(19) United States
(12) Patent Application Publication
(10) Pub. No.: US 2026/0216541 A1
(43) Pub. Date: Jul. 30, 2026

(54) FIRE EXTINGUISHING AND TEHRMAL LOAD COOLING ARRANGEMENT AND FIRE EXTINGUISHING

(71) Applicant: HypInno Oy, Kaarina (FI)

(72) Inventor: Tero Setälä, Kaarina (FI)

(73) Assignee: HypInno Oy, Kaarina (FI)

(21) Appl. No.: 19/145,979

(22) PCT Filed: Dec. 19, 2023
(86) PCT No.: PCT/FI2023/050713

§ 371 Date: Jul. 7, 2025

(30) Foreign Application Priority Data
Jan. 18, 2023 (EP) 23152224.4

(51) Int. Cl. A62C 2/06; A62C 3/16

(52) U.S. Cl. CPC A62C 2/065; A62C 3/16

(57) ABSTRACT

A fire extinguishing and thermal load cooling arrangement includes a support structure configured to be arranged temporarily or permanently on a base surface for defining a fire protection area, and one or more expandable members mounted on the support structure. Moreover, the one or more expandable members are configured to attain a relaxed state and rest on the support structure. Furthermore, the one or more expandable members are configured to attain an inflated state when expanded fluidically or by gas in a vertical direction with respect to the base surface to form an inflated basin structure around the fire protection area. Disclosed also a fire extinguishing system.

### TECHNICAL FIELD

The present disclosure relates to fire extinguishing and thermal load cooling arrangements. The present disclosure also relates to fire extinguishing systems.

### BACKGROUND

In light of ongoing market demand for alternatives to internal combustion engines, the world appears to be in the midst of an electric vehicle (EV) renaissance, due to concerns regarding the environment and fluctuating oil prices. Notably, the auto industry is working to reduce carbon emissions. Moreover, the car owners are increasingly concerned with volatile oil prices. As a result, a growing number of users are considering EVs. In addition, governments worldwide are implementing programs to push the users toward EVs. Suitably, the EVs offer high efficiency and the lowest carbon emissions per mile, raising the potential for the elimination of oil usage.

Typically, the EVs require minimum regular maintenance. Also, the EVs require lesser need for oil changes and changes of mechanical components. However, due to the advancement in technology, the EVs are still susceptible to fire hazards due to the battery pack installed therein. Consequently, battery manufacturers are still working to overcome such hazards. Notably, there exist some systems for extinguishing the fire to prevent loss of property and life. However, such systems are not stationary and require a lot of space. Moreover, such systems are heavy and mechanically complex and require a lifting mechanism to place them into action to extinguish the fire.

In a United States patent document US 2022/134154 A1 (Rémi Vincent, Gilles ICART; “System for fire extinguishing a fire and/or Preventing the taking or resumption of an Electric Vehicle fire, associated operating method comprising a step of first lifting the vehicle off the ground”) there is described a system for extinguishing a fire and/or preventing a fire from starting or restarting in an electric vehicle having a module or a battery pack with a plurality of electrochemical batteries, in particular metal-ion batteries. The disclosure further includes a self-supporting inflatable structure, the shape and dimensions of which when deployed are configured to lift the electric vehicle off the ground, creating a liner between the ground and the electric vehicle, and creating a peripheral barrier in continuity with the liner, which is closed upon itself, around the electric vehicle.

In a South Korea patent document KR 102431474 B1 (CHEONG SOO HWAN; “Fire suppression water tank at electric vehicle charging station”), there is described a water tank for suppressing a fire which occurs during charging of an electric vehicle. The water tank includes a rectangular-shaped reservoir surrounding a vehicle entering a parking location of an electric vehicle charging station. Furthermore, the reservoir includes a storage body having a receiving groove with a certain width and depth along the periphery. Within the storage body, an air-injection-type-multi-layered wall tube having a central hole is customarily accommodated. The upper opening of the storage body can be opened and closed by an opening/closing cover. As air is injected into the air-injection-type multi-layered wall tube, the opening/closing cover automatically opens while the tube inflates. So, a water tank which surrounds the vehicle from all sides is configured by the inflated air-injection-type multi-layered wall tube, such that the water tank can be filled with water, thereby stabilizing the battery of the electric vehicle by submerging the battery in water.

Therefore, in light of the foregoing discussion, there exists a need to overcome the aforementioned drawbacks associated with the existing systems.

### SUMMARY

The present disclosure seeks to provide a fire extinguishing and thermal load cooling arrangement. The present disclosure also seeks to provide a fire extinguishing system. An aim of the present disclosure is to provide a solution that overcomes at least partially the problems encountered in prior art.

In one aspect, an embodiment of the present disclosure provides a fire extinguishing and thermal load cooling arrangement comprising:
a support structure configured to be arranged temporarily or permanently on a base surface for defining a fire protection area;
one or more expandable members mounted on the support structure, wherein the one or more expandable members are made of a metal material;
wherein the one or more expandable members are configured to attain a relaxed state and rest on the support structure, and
wherein the one or more expandable members are configured to attain an inflated state when expanded fluidically or by gas in a vertical direction with respect to the base surface to form an inflated basin structure around the fire protection area,
   the fire extinguishing and thermal load cooling arrangement further comprising:
a support-surround structure coupled to the base surface and arranged around the support structure, wherein the support-surround structure is configured to surround the support structure and the one or more expandable members when in the relaxed state; and
a cover plate configured to be placed on the support-surround structure for shielding the support structure and the one or more expandable members from an external load,
wherein the cover plate is configured to be lifted by the one or more expandable members when expanded fluidically or by gas to form the inflated basin structure.

In another aspect, an embodiment of the present disclosure provides a fire extinguishing system comprising:
at least one fire extinguishing and thermal load cooling arrangement, wherein each of the at least one fire extinguishing and thermal load cooling arrangement comprises:
   a support structure configured to be arranged temporarily or permanently on a base surface for defining a fire protection area, and
   one or more expandable members mounted on the support structure and conform to a shape of the support structure, wherein the one or more expandable members are configured to attain a relaxed state and an expanded-state, wherein the one or more expandable members are made of a metal material;
one or more hose or pipe configured to fluidically couple to the one or more expandable members and a fluid reservoir for expanding fluidically or by gas the one or more expandable members to form an inflated basin structure around the fire protection area and fill the inflated basin structure with fluid;
one or more valves arranged on the one or more hose or pipe for allowing flow of the fluid or gas through the one or more hose or pipe;
one or more sensors arranged in vicinity of the fire protection area and operable to sense a fire event; and
a processor communicably coupled to the one or more valves and the one or more sensors,
   wherein the one or more sensors are operable to send a signal indicative of the fire event to the processor and the processor is operable to send an activation signal to the one or more valves based on the signal indicative of the fire event, and the one or more valves are operable to allow flow of fluid or gas through the one or more hose or pipe to fluidically expand the one or more expandable members to form the inflated basin structure around the fire protection area and allow flow of the fluid or gas into the inflated basin structure for extinguishing a fire caused by a battery of a battery operable machine resting on the fire protection area,
   wherein each of the at least one fire extinguishing and thermal load cooling arrangement further comprises:
a support-surround structure coupled to the base surface and arranged around the support structure, wherein the support-surround structure is configured to surround the support structure and the one or more expandable members in the relaxed state; and
a cover plate configured to be placed on the support-surround structure for shielding the support structure and the one or more expandable members from an external load,
wherein the cover plate is configured to be lifted by the one or more expandable members when expanded fluidically or by gas to form the inflated basin structure.

Embodiments of the present disclosure substantially eliminate or at least partially address the aforementioned problems in the prior art, and enables an effective, cost-efficient and reliable arrangement to handle fire of electric vehicles.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIGS. 1A and 1B are schematic illustration of a fire extinguishing and thermal load cooling arrangement in relaxed state and inflated state, respectively, in accordance with an embodiment of the present disclosure;

FIGS. 2A and 2B illustrated are perspective view of a fire extinguishing and thermal load cooling arrangement, in accordance with the embodiment of the present disclosure;

FIGS. 3A and 3B illustrated are perspective view of a one or more expandable members in an inflated state and an exploded relaxed state, respectively, in accordance with the embodiment of the present disclosure;

FIGS. 4A and 4B illustrated are perspective view of a one or more expandable members in an inflated state and a relaxed state, respectively, in accordance with the embodiment of the present disclosure;

FIG. 5 is a schematic illustration of a fire extinguishing system, in accordance with the embodiment of the present disclosure; and

FIG. 6 is a schematic illustration of a fire extinguishing system, in accordance with the embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a fire extinguishing and thermal load cooling arrangement comprising:
a support structure configured to be arranged temporarily or permanently on a base surface for defining a fire protection area;
one or more expandable members mounted on the support structure, wherein the one or more expandable members are made of a metal material;
wherein the one or more expandable members are configured to attain a relaxed state and rest on the support structure, and
wherein the one or more expandable members are configured to attain an inflated state when expanded fluidically or by gas in a vertical direction with respect to the base surface to form an inflated basin structure around the fire protection area,
   the fire extinguishing and thermal load cooling arrangement further comprising:
a support-surround structure coupled to the base surface and arranged around the support structure, wherein the support-surround structure is configured to surround the support structure and the one or more expandable members when in the relaxed state; and
a cover plate configured to be placed on the support-surround structure for shielding the support structure and the one or more expandable members from an external load,
wherein the cover plate is configured to be lifted by the one or more expandable members when expanded fluidically or by gas to form the inflated basin structure.

In another aspect, an embodiment of the present disclosure provides a fire extinguishing system comprising:
at least one fire extinguishing and thermal load cooling arrangement, wherein each of the at least one fire extinguishing and thermal load cooling arrangement comprises:
   a support structure configured to be arranged temporarily or permanently on a base surface for defining a fire protection area, and
   one or more expandable members mounted on the support structure and conform to a shape of the support structure, wherein the one or more expandable members are configured to attain a relaxed state and an expanded-state, wherein the one or more expandable members are made of a metal material;
one or more hose or pipe configured to fluidically couple to the one or more expandable members and a fluid reservoir for fluidically expanding the one or more expandable members to form an inflated basin structure around the fire protection area and fill the inflated basin structure with fluid or gas;
one or more valves arranged on the one or more hose or pipe for allowing flow of the fluid or gas through the one or more hose or pipe;
one or more sensors arranged in vicinity of the fire protection area and operable to sense a fire event; and
a processor communicably coupled to the one or more valves and the one or more sensors,
wherein the one or more sensors are operable to send a signal indicative of the fire event to the processor and the processor is operable to send an activation signal to the one or more valves based on the signal indicative of the fire event, and the one or more valves are operable to allow flow of fluid or gas through the one or more hose or pipe to expand fluidically or by gas the one or more expandable members to form the inflated basin structure around the fire protection area and allow flow of the fluid or gas into the inflated basin structure for extinguishing a fire caused by a battery of a battery operable machine resting on the fire protection area,
   wherein each of the at least one fire extinguishing and thermal load cooling arrangement further comprises:
a support-surround structure coupled to the base surface and arranged around the support structure, wherein the support-surround structure is configured to surround the support structure and the one or more expandable members in the relaxed state; and
a cover plate configured to be placed on the support-surround structure for shielding the support structure and the one or more expandable members from an external load,
wherein the cover plate is configured to be lifted by the one or more expandable members when expanded fluidically or by gas to form the inflated basin structure.

The present disclosure provides the fire extinguishing and thermal load cooling arrangement that is configured to form the inflated basin structure around the fire protection area. Moreover, the inflated basin structure is filled using the fluid or gas and serves to cool down and extinguish a battery fire of an electric vehicle. Advantageously, the fire extinguishing and thermal load cooling arrangement is easy and fast to install in any suitable location. Furthermore, the fire extinguish system comprises one or more fire extinguishing and thermal load cooling arrangement installed in any suitable location enables extinguishing fire in case of fire event.

Throughout the present disclosure, the term “fire extinguishing arrangement” as used herein refers to an arrangement configured to extinguish or handle fire caused in electric vehicles (EVs). The term “thermal load cooling” as used herein refers to an amount of energy needed to be added or removed from an arrangement to maintain an optimum temperature thereof. The disclosed fire extinguishing and thermal load cooling arrangement is a compact, pressure-driven arrangement that extinguishes fire (such as a battery fire of the EV) by utilizing fluid (such as water) or gas (such as carbon dioxide) to reduce the temperature produced due to the fire. Optionally, the fire extinguishing and thermal load cooling arrangement is installed on a deck of marine vessels, parking places, trains, trucks or any other suitable locations. It will be appreciated that the said fire extinguishing and thermal load cooling arrangement is installed using at least one of: the screw and bolts, locking mechanism, adhesives glue, adhesive tapes or any combination thereof. Beneficially, the fire extinguishing and thermal load cooling arrangement is easy and fast to install in any suitable location.

The fire extinguishing and thermal load cooling arrangement is configured to extinguish the fire in the EVs in an effective and accurate manner. Moreover, the fire extinguishing and thermal load cooling arrangement is designed to handle the fire hazards. For example, the fire extinguishing and thermal load cooling arrangement is arranged in the parking place and the parked EV caught fire, in such a scenario the fire extinguishing and thermal load cooling arrangement is configured to handle the fire and also prevent other parked vehicles from catching the fire. The fire extinguishing and thermal load cooling arrangement is also configured to maintain the optimum temperature in the vicinity.

The term “support structure” as used herein refers to a structure formed on a base surface to support the fire extinguishing and thermal load cooling arrangement. The support structure is constructed to define the boundaries of the fire extinguishing and thermal load cooling arrangement. In an example, the support structure is a rail structure. Notably, the term “base surface” as used herein refers to a surface over which the support structure is constructed. It will be appreciated that the base surface is the floor of any suitable location. Moreover, the support structure is configured to define the fire protection area. Suitably, the support structure is arranged temporarily or permanently on a base surface for defining a fire protection area.

The term “fire protection area” as used herein refers to the region formed on the base surface by the support structure. Notably, the support structure is formed on the edges of the fire protection area. Suitably, the construction of the fire protection area minimizes the possibility of fire reaching out and affecting the people and vehicles in the vicinity. In other words, the fire protection area reduces the probability of catastrophic fire hazards.

The term “hollow expandable member” as used herein refers to a bellow type structure that expands and contracts due to a change in pressure. It will be appreciated that the one or more hollow expandable members are arranged to form the support structure. Notably, the change in pressure enables the one or more hollow expandable members to change state from the relaxed state to the inflated state. The term “relaxed state” as used herein refers to a state when the one or more hollow expandable members are at low tension (or zero tension), i.e., when pressure is absent. The term “inflated state” as used herein refers to the state when the one or more hollow expandable members are at high tension (or greater than zero tension), i.e., when pressure is applied. It will be appreciated that during the application of the pressure the one or more hollow expandable members are configured to change their form from the relaxed state to the inflated state. Moreover, when the optimum pressure is achieved, the one or more expandable members form the inflated basin structure. Optionally, the one and more hollow expandable members is continuous tubular structure. More optionally, the one and more hollow expandable members is elongated structure connected using a flexible member. Optionally, the flexible member may be fabricated from plastic, rubber and the like and is configured to be filled with the fluid. Optionally, the flexible member can be filled with fluid or gas.

Optionally, the one or more expandable members comprises a plurality of tubular members, each of the plurality of tubular members is adjoining to an adjacent tubular member and comprising one or more holes conforming to one or more holes of the adjacent tubular member configured at a contact area therebetween. The term “tubular member” as used herein refers to an elongated structure having a central hole along its entire length. Optionally, the one or more expandable members have a cylindrical section, or of any type, for example, circular, oval, elliptical, square, rectangular, and even I-shaped, H-shaped, U-shaped, W-shaped, L-shaped, Z-shaped, X-shaped, V-shaped, S-shaped, T-shaped, Y-shaped, and the like. It will be appreciated that the plurality of tubular members is configured to form the walls of the support structure over the fire-protected area. Suitably, each of the plurality of tubular members is stacked upon each other such that the one or more holes conform to one or more holes of the consecutive tubular member.

Optionally, the fire extinguishing and thermal load cooling arrangement further comprises one or more first hose or pipe configured to fluidically couple the one or more expandable members to a fluid reservoir for receiving fluid or gas from the fluid reservoir to expand fluidically or by gas the one or more expandable members. Optionally, the fire extinguishing and thermal load cooling arrangement comprises one or more first hose. Optionally, the fire extinguishing and thermal load cooling arrangement comprises one or more first pipe. The term “hose or pipe” as used herein refers to a tubular structure through which fluid or gas enters into the one or more expandable members. It will be appreciated that the one or more first hose or pipe may have an appropriate size or a diameter to provide a continuous flow of fluid or gas in the fire extinguishing and thermal load cooling arrangement. In this regard, the one or more first hose or pipe is configured to carry the fluid or gas from the fluid reservoir to the one or more expandable members to expand the support structure. The term “fluid reservoir” as used herein refers to the container or chamber containing a fluid or gas therein. Optionally, the fluid reservoir is a circular container, a rectangular container, a square container, or any other polygonal container. Suitably, the fluid reservoir is operable to provide the optimum pressure within the one or more first hose or pipe to expand the one or more expandable members. Moreover, the fluid reservoir may comprise a pump operably coupled with the fluid reservoir configured to direct the fluid or gas from the fluid reservoir to the one or more hollow expandable members through the one or more first hose or pipe.

The term “inflated basin structure” as used herein refers to a vessel formed by the bellows type unit configured to hold fluid or gas therein. Notably, the inflated basin structure is formed to extinguish the fire by the application of the fluid or gas stored therein. Optionally, the inflated basin structure possesses a circular, a rectangle, a square, a triangle or any other polygonal shape. Optionally, the fire extinguishing and thermal load cooling arrangement comprises a sprinkle. Optionally, the fire extinguishing and thermal load cooling arrangement further comprises one or more second hose or pipe arranged on at least one of: the support structure, the base surface, wherein the one or more second hose or pipe is fluidically coupled to the fluid reservoir, and wherein the one or more second hose or pipe is configured to fill the inflated basin structure with the fluid or gas from the fluid reservoir. In this regard, the one or more second hose or pipe is affixed between the fluid reservoir and the inflated basin structure. Beneficially, the one or more second hose or pipe enable the quick filling of the inflated basin structure to extinguish the fire. Moreover, the one or more second hose or pipe is also configured to maintain optimum fluid or gas level in the inflated basin structure. In particular, the number of the one or more expandable members determine the height of the inflated basin structure.

Optionally, the inflated basin structure is configured to contain the fluid or gas therein for extinguishing a fire caused by a battery of a battery operable machine resting on the fire protection area. In this regard, the inflated basin structure forms the region around the fire protection area and is operable to extinguish the fire caused by the battery. The term “battery operable machine” as used herein refers to a machine that requires a battery for its operation. Optionally, the battery operable machine is EV. Notably, the inflated basin structure holds the fluid or gas therein. In particular, the fluid or gas is delivered into the inflated basin structure using at least one of: the one or more first hose or pipe or the one or more second hose or pipe.

Optionally, the one or more first hose or pipe and the one or more second hose or pipe is simultaneously receiving the fluid or gas from the fluid reservoir for expanding fluidically or by gas (or optionally with a combination of fluid or gas) the one or more expandable members and filling an inflated basin structure formed by expanding the one or more expandable members. Optionally, the fluid reservoir comprises at least two openings configured to allow the fluid or gas to flow into the fire extinguishing and thermal load cooling arrangement. In this regard, the one or more first hose or pipe and the one or more second hose or pipe is connected using the said at least two opening to the fluid reservoir for fluidically expanding the one or more expandable members and filling an inflated basin.

Optionally, the one or more first hose or pipe and the one or more second hose or pipe is simultaneously receiving the fluid or gas from the fluid reservoir for expanding fluidically or by gas (or optionally with a combination of fluid and gas). Optionally, it can be that there are outlets or holes or similar in the expandable members, from which the fluid (like water or other suitable fluid for cooling and fire extinguishing) is coming out for cooling/extinguishing purposes and the gas is expanding the expanding member at the same time. Optionally, the expandable members are constructed so, that the outlets/holes where the fluid/gas can exit the expandable members, are of different shape/size, and located at different places (for example so that there are only a few holes of different size in the lower/higher/middle part of the expandable members) in the expandable members, so that the fluid/gas will exit the expandable member in a optimum way to expand the expandable member/s and also at the same time enough fluid is coming out of the expandable member for cooling/fire extinguishing purposes.

Optionally, a given expandable member distal to the support structure comprises at least one rupturable-area configured to rupture for allowing the fluid or gas to fill the inflated basin structure, when the one or more expandable members are in the inflated state. In this regard, the fluid or gas starts to fill from the bottom of the one or more expandable members. Suitably, each of the one or more expandable member starts to fill from the bottom, expanding the one or more expandable members from the relaxed state to the inflated state, thereby raising the pressure therein. The one or more expandable members form the inflated basin structure. It will be appreciated that the change in shape of the one or more expandable members is permanent and the inflated basin structure remains in an upright position. When the one or more expandable members reaches the inflated state, however, the pressure continues to rise and the upper expandable member from the one or more expandable member has at least one rupturable-area. ruptures allowing the fluid or gas to fill the inflated basin structure. The term “rupturable area” as used herein refers to an area that is capable of being ruptured during the application of suitable pressure. The rupturable area ruptures during the application of suitable pressure allowing the fluid or gas to fill the inflated basin structure.

Optionally, the support structure also comprises a plurality of holes arranged to allow fluid or gas to drain in normal situations. Notably, when the one or more expandable members is in the inflated state, the bottom member of the one or more expandable members closes the plurality of holes when filled with the fluid or gas and closes the drain channel. Optionally, the bottom member of the one or more expandable members is fabricated from fireproof material.

The one or more expandable members are made of at least one of: a metal material, a plastic material, a rubber material, a fibre material. The one or more expandable members are made of the metal material such as steel, aluminium, and the like. Optionally, the one or more expandable members are made of the plastic material such as Polyethylene Terephthalate (PET or PETE), High-Density Polyethylene (HDPE), Polyvinyl Chloride (PVC or Vinyl), Low-Density Polyethylene (LDPE), Polypropylene (PP), Polystyrene (PS or Styrofoam) and the like. Optionally, the one or more expandable members are made of the rubber material Natural Rubber (NR), Styrene-butadiene Rubber (SBR), Butyl Rubber (IIR), Nitrile (NBR), Neoprene® (CR) and the like. Optionally, the one or more expandable members are made of the fibre material such as wool, cotton, carbon, glass, polymer fibre, and the like.

The fire extinguishing and thermal load cooling arrangement further comprises:
a support-surround structure coupled to the base surface and arranged around the support structure, wherein the support-surround structure is configured to surround the support structure and the one or more expandable members when in the relaxed state, and
a cover plate configured to be placed on the support-surround structure for shielding the support structure and the one or more expandable members from an external load.

In this regard, the term “support-surround structure” as used herein refers to a solid framework that provides a rigid support to the support structure. The support-surround structure includes components extending vertically and horizontally arranged together to form the solid framework. Optionally, the support-surround structure is composed of at least one of a metal, a non-metal, an alloy, plastic, rubber, wood or a combination thereof.

The term “cover plate” as used herein refers to the covering configured to cover the support-surround structure from a top side of the fire extinguishing and thermal load cooling arrangement to protect the support structure. Optionally, the cover plate is made of an insulating material. The insulating material may plastic, rubber, and the like. Optionally, the cover plate may be manufactured using 3D printer.

The cover plate is configured to be lifted by the one or more expandable members when fluidically expanded fluidically or by gas (or by a combination of the aforementioned) to form the inflated basin structure. In this regard, the cover plate is placed on the support-surround structure for shielding the support structure. Notably, during the expansion of the one or more expandable members to form the inflated basin structure the cover plate moves from a first position to a second position. It will be appreciated that the first position may be the initial position of the cover plate during the relaxed state of the one or more expandable members. In addition, the second position may be the final position of the cover plate during the inflated state of the one or more expandable members.

The present disclosure also relates to the fire extinguishing system as described above. Various embodiments and variants disclosed above apply mutatis mutandis to the fire extinguishing system.

The term “fire extinguishing system” as used herein refers to a system operable to extinguish, control, or prevent fire from spreading. The fire extinguishing system is arranged to detect the fire during the fire event. The fire extinguishing system may be considered as an active fire protection as the system is triggered in response to the presence of fire. Optionally, the fire extinguishing system eliminates the need for human activation or intervention, thereby increasing the safety of the human/vehicle rider. Optionally, the fire extinguishing system supports fire extinguishing in remote or less accessible areas. Optionally, the fire extinguishing system may utilize chemical agents, inert gases, carbon-dioxide (CO₂), or water and the like to extinguish fire.

Moreover, the one or more valves arranged on the one or more hose or pipe for allowing flow of the fluid or gas through the fluid reservoir. Notably, the opening and/or closing of one or more valves allows to regulate the flow from the fluid reservoir to the inflated basin structure.

The term “sensor” as used herein refers to a device, module, machine, or subsystem that detects changes in its environment. Optionally, the sensor is a flame-sensor that is configured to detect the fire event. Optionally, the sensor is a level sensor that is configured to detect the level of the fluid or gas within the inflated basin structure. When the optimum level of water is reached, the sensor is configured to indicate the processor

The term “processor” as used herein refers to a computational element that is operable to respond to and processes instructions that drive the fire extinguishing system for detecting fire event within the fire protected area. The processor includes, but is not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the processor may refer to one or more individual processors, processing devices and various elements associated with a processing device that may be shared by other processing devices. Additionally, the one or more individual processors, processing devices and elements are arranged in various architectures for responding to and processing the instructions that drive the fire extinguishing system.

It will be appreciated that the one or more sensors are operable to send a signal indicative of the fire event to the processor. The term “signal indicative” as used herein refers to a function that conveys (namely, carries) information about the fire event. Typically, the signal indicative could be a voltage, a current, or an electronic wave that varies as a function of time. Specifically, the signal indicative is the observable change. More specifically, signal indicative is typically provided by one or more sensors specific for observing said change in the quality, subsequently, signal indicative is converted to another suitable form of energy using a transducer.

Moreover, based on the signal indicative of the fire event the processor is operable to send an activation signal to the one or more valves. The activation signal is a command for the one and more valves to operate. For example, in case of the fire event, the processor after receiving the activation signal allows the one and more valves to open and when fire is extinguished the processor is configured to close the one and more valves when the optimum level of the fluid or gas within the inflated basin surface is reached. Furthermore, the one or more valves are operable to allow flow of fluid or gas through the one or more hose or pipe to fluidically expand the one or more expandable members to form the inflated basin structure around the fire protection area and allow the flow of the fluid or gas into the inflated basin structure for extinguishing a fire caused by a battery of a battery operable machine resting thereon.

The at least one fire extinguishing and thermal load cooling arrangement further comprises:
a support-surround structure coupled to the base surface and arranged around the support structure, wherein the support-surround structure is configured to surround the support structure and the one or more expandable members in the relaxed state; and
a cover plate configured to be placed on the support-surround structure for shielding the support structure and the one or more expandable members from an external load.

Optionally, the fire extinguishing system further comprises a sprinkler arrangement arranged over the fire protection area and communicably coupled to the processor and configured to get activated for sprinkling the fluid or gas into the inflated basin structure in case of the fire event. The term “sprinkler arrangement” as used herein refers to an arrangement having perforation on the surface and is configured to sprinkle fluid. It will be appreciated that the sprinkler arrangement is arranged in vicinity of the fire protected area. Optionally, the sprinkler arrangement is arranged on the support structure. The processor is configured to control the sprinkler arrangement to sprinkle the fluid or gas in the inflated basin surface when the fire event is detected and is also configured to stop the sprinkler arrangement when the optimum level of the fluid or gas is reached within the inflated basin surface.

Optionally, the processor is further communicably coupled to a user device for sending an alert to the user device regarding the fire event and depicting on a display of the user device of a given fire extinguishing and thermal load cooling arrangement of the at least one fire extinguishing and thermal load cooling arrangement, that is subjected to the fire event. The term “user device” as used herein refers to an electronic device associated with (or used by) a user, that is capable of enabling the user to perform specific tasks associated with the aforementioned system. Furthermore, the user device is intended to be broadly interpreted to include any electronic device that may be used for voice and/or data communication over a wireless communication network. Examples of user device include, but are not limited to, cellular phones, personal digital assistants (PDAs), handheld devices, wireless modems, laptop computers, personal computers, etc. Additionally, the user device includes a display, a camera, a memory, a processor, a communication interface. Optionally, the user device is configured to host the application programming interface thereon to support and/or enable the operation of the system. The user device is operable to receive the alert associated with the fire event at the given fire extinguishing and thermal load cooling arrangement. The term “alert” as used herein refers to a notification corresponding to the fire event, which is sent on the user device to inform the user associated with the user device.

Optionally, the base surface is a support surface of a transportation means including at least one of: a marine vessel, an air freight, a freight train, a truck, or a parking place, designed for supporting the battery operable machine thereon. In this regard, the support surface is fabricated from the non-metal, metal, alloy or combination thereof and is configured to hold the transportation means. The fabricated material of the support surface is corrosion resistive, chemical resistive and light weighted.

Optionally, there is at least one temperature sensor for measuring the temperature of the fluid which fills the inflated basin structure. With measuring the temperature of the fluid, it is possible to assure that the extinguishing and/cooling of the battery of the EV has succeeded, for example so that if the temperature of the fluid is below a pre-determined value, then the cooling can be ended.

Optionally, there are at least two temperature sensors, for measuring the temperature gradient of the fluid, and which temperature sensors are located at a distance of each other. It is possible that one sensor is located for example at the bottom of the inflated basin, and a second sensor is located at the top part of inflated basin, so that the temperature gradient of the fluid can be measured using measurements from two (or more) different locations.

Optionally, the measured temperature or temperature gradient of the fluid is being used for controlling the fluid level of the inflated basin structure.

Optionally, the one or more valves are configured to allow the flow of the fluid through the one or more hose or pipe to the inflated basin structure to keep the temperature or temperature gradient of the fluid in a pre-determined range, and wherein the flow of the fluid is controlled based on the temperature or temperature gradient of the fluid.

With measuring the temperature or temperature gradient of the fluid, it is possible to get information of how well the extinguishing of the EV battery fire is proceeding or has proceeded and also it is possible to get information and control the cooling of the EV battery.

### DETAILED DESCRIPTION OF THE DRAWINGS

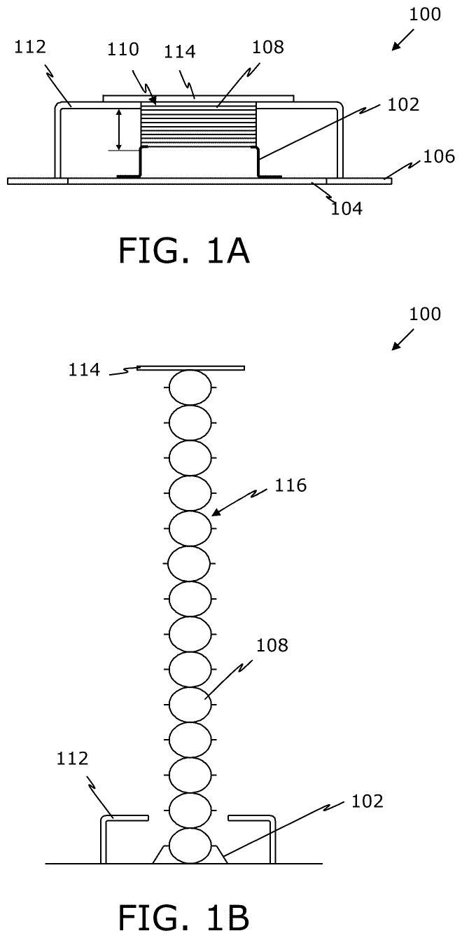

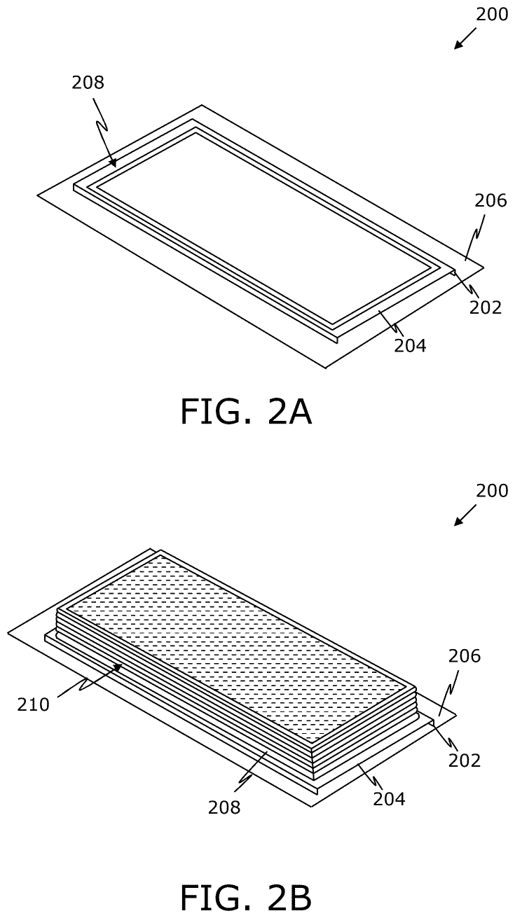

Referring to FIGS. 1A and 1B are schematic illustration of a fire extinguishing and thermal load cooling arrangement 100 in relaxed state and inflated state, respectively, in accordance with an embodiment of the present disclosure. As shown in FIGS. 1A and 1B, the fire extinguishing and thermal load cooling arrangement 100 comprises a support structure 102 configured to be arranged temporarily or permanently on a base surface 104 for defining a fire protection area 106. The fire extinguishing and thermal load cooling arrangement 100 further comprises one or more expandable members 108 mounted on the support structure 102. Referring to FIG. 1A, the one or more expandable members 108 are configured to attain a relaxed state 110 and rest on the support structure 102. Moreover, a support-surround structure 112 coupled to the base surface 104 and arranged around the support structure 102, wherein the support-surround structure 112 is configured to surround the support structure 102 and the one or more expandable members 108 when in the relaxed state 110. The fire extinguishing and thermal load cooling arrangement 100 also comprises a cover plate 114 configured to be placed on the support-surround structure 112 for shielding the support structure 102 and the one or more expandable members 108 from an external load. Referring to FIG. 1B, the one or more expandable members 108 are configured to attain an inflated state 116 when expanded fluidically or by gas in a vertical direction with respect to the base surface 104 to form an inflated basin structure (as shown in FIG. 2) around the fire protection area 106.

Referring to FIGS. 2A and 2B, illustrated are perspective view of a fire extinguishing and thermal load cooling arrangement 200, in accordance with the embodiment of the present disclosure. As shown in FIGS. 2A and 2B, the fire extinguishing and thermal load cooling arrangement 200 comprises a support structure 202 configured to be arranged temporarily or permanently on a base surface 204 for defining a fire protection area 206. The fire extinguishing and thermal load cooling arrangement 200 further comprises one or more expandable members 208 mounted on the support structure 202. Referring to FIG. 2A, the one or more expandable members 208 are configured to attain a relaxed state 210 and rest on the support structure 202. Referring to FIG. 2B, the one or more expandable members 208 are configured to attain an inflated state 212 to form an inflated basin structure 214 around the fire protection area 206.

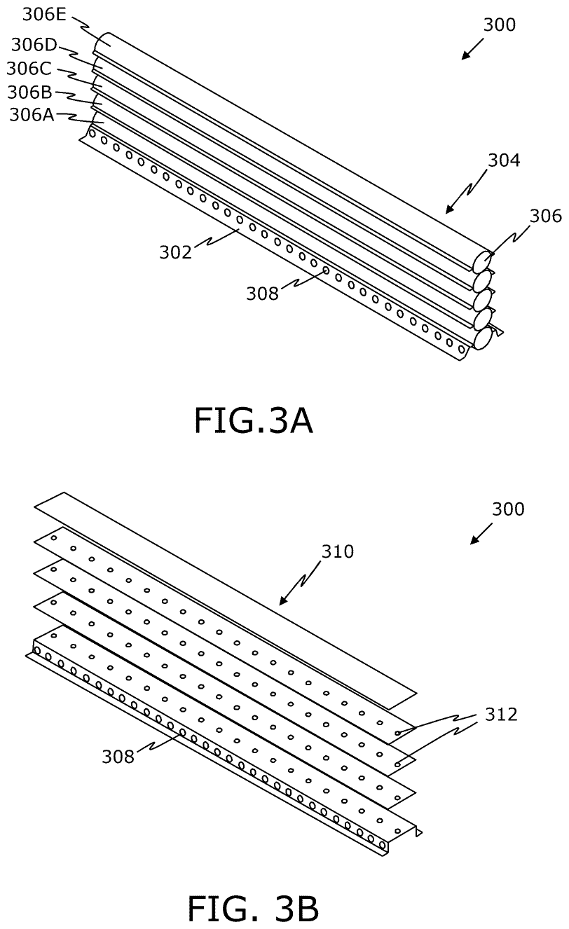

Referring to FIGS. 3A and 3B, illustrated are perspective view of a one or more expandable members 300 in an inflated state and an exploded relaxed state, respectively, in accordance with the embodiment of the present disclosure. As shown in FIG. 3A, the one or more expandable members 300 mounted on the support structure 302 in the inflated state 304. The one or more expandable members 300 comprises a plurality of tubular members 306, each of the plurality of tubular members 306A, 306B, 306C, 306D and 306E are adjoining to an adjacent tubular member. The one or more expandable members 300 comprises plurality of holes 308 in a support structure 302 to allow fluid or gas to drain in normal condition. As shown in FIG. 3B, the one or more expandable members 300 an exploded relaxed state 310. The one or more expandable members 300 comprises one or more holes 312 conforming to one or more holes of the adjacent tubular member 306 configured at a contact area therebetween.

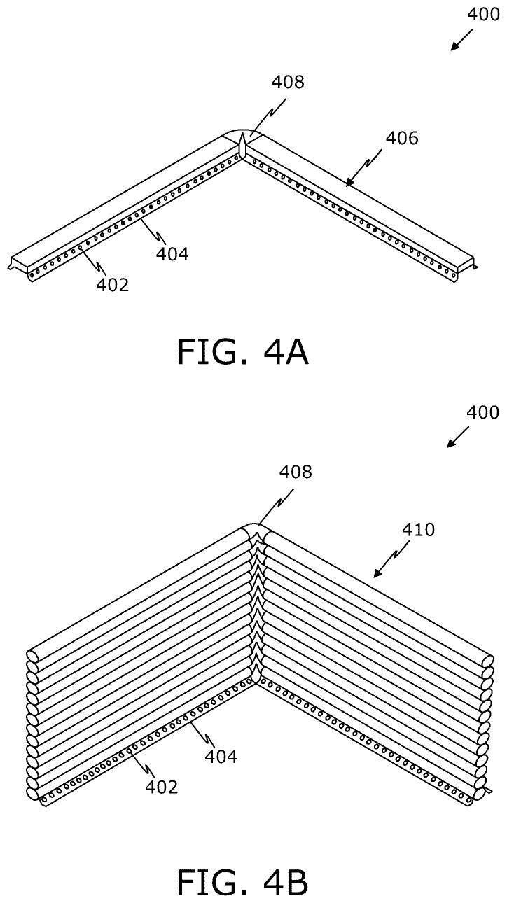

Referring to FIGS. 4A and 4B, illustrated are perspective view of a one or more expandable members 400 in an inflated state and a relaxed state, respectively, in accordance with the embodiment of the present disclosure. Referring to FIGS. 4A and 4B, the one or more expandable members 400 comprises plurality of holes 402 in a support structure 404 to allow fluid or gas to drain in normal condition. As shown in FIG. 4A, the one or more expandable members 400 in the relaxed state 406. The one or more expandable members 400 is connected using a flexible member 408 (like in the drawings, the flexible member is a cornerpiece, which connects the expandable members). As shown in FIG. 4B, the one or more expandable members 400 in the inflated state 410 The one or more expandable members 400 is connected using a flexible member 408 to form an inflated structure. Optionally, it might be that the cornerpiece can be filled with a fluid or gas or a combinations of the aforementioned, and expands when filled, so that the cornerpiece raises the expandable members 404, because the flexible member 408 is connected to the expandable members 400.

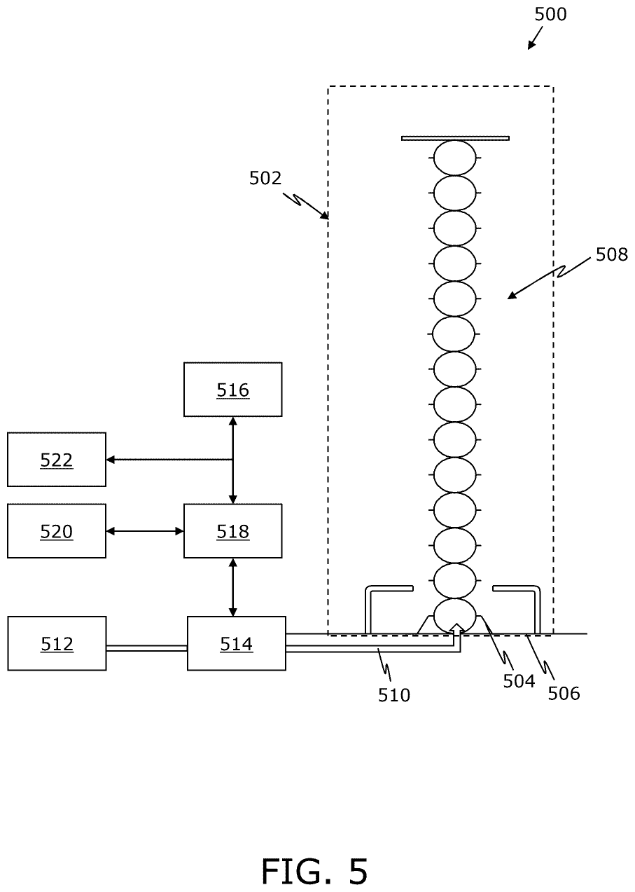

Referring to FIG. 5, is a schematic illustration of a fire extinguishing system 500, in accordance with the embodiment of the present disclosure. As shown, the fire extinguishing system 500 comprises at least one fire extinguishing and thermal load cooling arrangement 502, wherein each of the at least one fire extinguishing and thermal load cooling arrangement comprises a support structure 504 configured to be arranged temporarily or permanently on a base surface 506 for defining a fire protection area, and one or more expandable members 508 mounted on the support structure 504 and conform to a shape of the support structure 504, wherein the one or more expandable members 508 are configured to attain a relaxed state and an expanded-state. The fire extinguishing system 500 further comprises one or more hose or pipe 510 configured to fluidically couple to the one or more expandable members 508 and a fluid reservoir 512 for fluidically expanding the one or more expandable members 508 to form an inflated basin structure around the fire protection area and fill the inflated basin structure with fluid or gas, one or more valves 514 arranged on the one or more hose or pipe 510 for allowing flow of the fluid or gas through the one or more hose or pipe 510, one or more sensors 516 arranged in vicinity of the fire protection area and operable to sense a fire event and a processor 518 communicably coupled to the one or more valves 514 and the one or more sensors 516. Moreover, the one or more sensors 516 are operable to send a signal indicative of the fire event to the processor 518 and the processor 518 is operable to send an activation signal to the one or more valves 514 based on the signal indicative of the fire event, and the one or more valves 514 are operable to allow flow of fluid or gas through the one or more hose or pipe 510 to fluidically expand the one or more expandable members 508 to form the inflated basin structure around the fire protection area and allow flow of the fluid or gas into the inflated basin structure for extinguishing a fire caused by a battery of a battery operable machine resting on the fire protection area.

Moreover, the fire extinguishing system 500 further comprises a sprinkler arrangement 520 arranged over the fire protection area and communicably coupled to the processor 518 and configured to get activated for sprinkling the fluid into the inflated basin structure in case of the fire event. Furthermore, the processor 518 is further communicably coupled to a user device 522 for sending an alert to the user device 522 regarding the fire event and depicting on a display of the user device 522 of a given fire extinguishing and thermal load cooling arrangement 500 of the at least one fire extinguishing and thermal load cooling arrangement 500, that is subjected to the fire event.

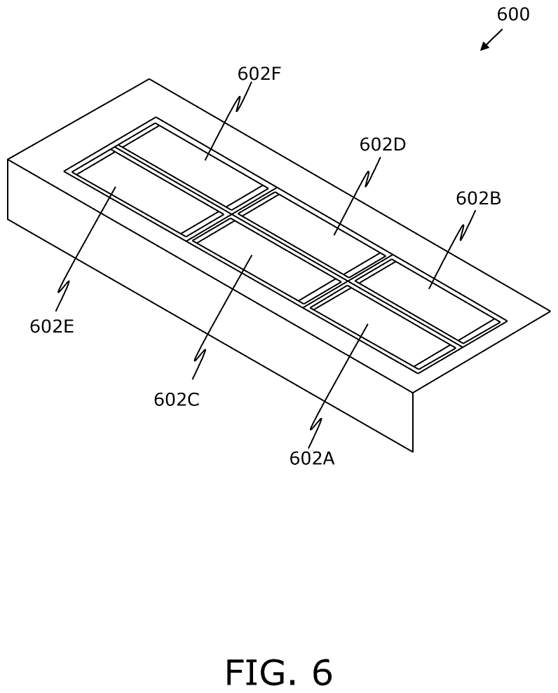

Referring to FIG. 6, is a schematic illustration of a fire extinguishing system 600, in accordance with the embodiment of the present disclosure. As shown, the fire extinguishing system 600 comprises one or more fire extinguishing and thermal load cooling arrangement 602A, 602B, 602C, 602D, 602E and 602F collectively referred as 602.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A fire extinguishing and thermal load cooling arrangement comprising:
a support structure configured to be arranged temporarily or permanently on a base surface for defining a fire protection area;
one or more expandable members mounted on the support structure, wherein the one or more expandable members are made of a metal material;
wherein the one or more expandable members are configured to attain a relaxed state and rest on the support structure, and
wherein the one or more expandable members are configured to attain an inflated state when expanded fluidically or by gas in a vertical direction with respect to the base surface to form an inflated basin structure around the fire protection area,
the fire extinguishing and thermal load cooling arrangement further comprising:
a support-surround structure coupled to the base surface and arranged around the support structure, wherein the support-surround structure is configured to surround the support structure and the one or more expandable members when in the relaxed state; and
a cover plate configured to be placed on the support-surround structure for shielding the support structure and the one or more expandable members from an external load,
wherein the cover plate is configured to be lifted by the one or more expandable members when expanded fluidically or by gas to form the inflated basin structure.

2. The fire extinguishing and thermal load cooling arrangement according to claim 1, wherein the one or more expandable members comprises a plurality of tubular members, each of the plurality of tubular members is adjoining to an adjacent tubular member and comprising one or more holes conforming to one or more holes of the adjacent tubular member configured at a contact area therebetween.

3. The fire extinguishing and thermal load cooling arrangement according to claim 1, further comprising one or more first hose or pipe configured to fluidically couple the one or more expandable members to a fluid reservoir for receiving fluid or gas from the fluid reservoir to expand fluidically or by gas the one or more expandable members.

4. The fire extinguishing and thermal load cooling arrangement according to claim 3, further comprising one or more second hose or pipe arranged on at least one of: the support structure, the base surface, wherein the one or more second hose or pipe is fluidically coupled to the fluid reservoir, and wherein the one or more second hose or pipe is configured to fill the inflated basin structure with the fluid or gas from the fluid reservoir.

5. The fire extinguishing and thermal load cooling arrangement according to claim 4, wherein the inflated basin structure is configured to contain the fluid or gas therein for extinguishing a fire caused by a battery of a battery operable machine resting on the fire protection area.

6. The fire extinguishing and thermal load cooling arrangement according to claim 4, wherein the one or more first hose or pipe and the one or more second hose or pipe is simultaneously receiving the fluid or gas from the fluid reservoir for expanding fluidically or by gas the one or more expandable members and filling an inflated basin structure formed by expanding the one or more expandable members.

7. The fire extinguishing and thermal load cooling arrangement according to claim 1, wherein a given expandable member distal to the support structure comprises at least one rupturable-area configured to rupture for allowing the fluid or gas to fill the inflated basin structure, when the one or more expandable members are in the inflated state.

8. A fire extinguishing system comprising:
at least one fire extinguishing and thermal load cooling arrangement, wherein each of the at least one fire extinguishing and thermal load cooling arrangement comprises:
a support structure configured to be arranged temporarily or permanently on a base surface for defining a fire protection area, and
one or more expandable members mounted on the support structure and conform to a shape of the support structure, wherein the one or more expandable members are configured to attain a relaxed state and an expanded-state, wherein the one or more expandable members are made of a metal material;
one or more hose or pipe configured to fluidically couple to the one or more expandable members and a fluid reservoir for expanding fluidically or by gas the one or more expandable members to form an inflated basin structure around the fire protection area and fill the inflated basin structure with fluid or gas;
one or more valves arranged on the one or more hose or pipe for allowing flow of the fluid or gas through the one or more hose or pipe;
one or more sensors arranged in vicinity of the fire protection area and operable to sense a fire event; and
a processor communicably coupled to the one or more valves and the one or more sensors,
wherein the one or more sensors are operable to send a signal indicative of the fire event to the processor and the processor is operable to send an activation signal to the one or more valves based on the signal indicative of the fire event, and the one or more valves are operable to allow flow of fluid or gas through the one or more hose or pipe to expand fluidically or by gas the one or more expandable members to form the inflated basin structure around the fire protection area and allow flow of the fluid or gas into the inflated basin structure for extinguishing a fire caused by a battery of a battery operable machine resting on the fire protection area,
wherein each of the at least one fire extinguishing and thermal load cooling arrangement further comprises:
a support-surround structure coupled to the base surface and arranged around the support structure, wherein the support-surround structure is configured to surround the support structure and the one or more expandable members in the relaxed state; and
a cover plate configured to be placed on the support-surround structure for shielding the support structure and the one or more expandable members from an external load,
wherein the cover plate is configured to be lifted by the one or more expandable members when expanded fluidically or by gas to form the inflated basin structure.

9. The fire extinguishing system according to claim 8, further comprising a sprinkler arrangement arranged over the fire protection area and communicably coupled to the processor and configured to get activated for sprinkling the fluid or gas into the inflated basin structure in case of the fire event.

10. The fire extinguishing system according to claim 8, wherein the processor is further communicably coupled to a user device for sending an alert to the user device regarding the fire event and depicting on a display of the user device of a given fire extinguishing and thermal load cooling arrangement of the at least one fire extinguishing and thermal load cooling arrangement, that is subjected to the fire event.

11. The fire extinguishing system according to claim 8, wherein the base surface is a support surface of a transportation means including at least one of: a marine vessel, an air freight, a freight train, a truck, or a parking place, designed for supporting the battery operable machine thereon.

12. The fire extinguishing system according to claim 8, wherein there is at least one temperature sensor for measuring the temperature of the fluid which fills the inflated basin structure.

13. The fire extinguishing system according to claim 8, wherein there are at least two temperature sensors, for measuring the temperature gradient of the fluid, and which temperature sensors are located at a distance of each other.

14. The fire extinguishing system according to claim 8, wherein the measured temperature or temperature gradient of the fluid is being used for controlling the fluid level of the inflated basin structure.

15. The fire extinguishing system according to claim 8, wherein the one or more valves are configured to allow the flow of the fluid through the one or more hose or pipe to the inflated basin structure to keep the temperature or temperature gradient of the fluid in a pre-determined range and wherein the flow of the fluid is controlled based on the temperature or temperature gradient of the fluid.
